(19) United States
(12) Patent Application Publication
(10) Pub. No.: US 2009/0283013 A1
(43) Pub. Date: Nov. 19, 2009

(54) Liquid composition, manufacturing method thereof, low dielectric constant films, abrasive materials, and electronic components

(75) Inventors: Takayuki Takahagi, Higashi-Hiroshima city (JP); Hiroyuki Sakaue, Higashi-Hiroshima (JP); Shoso Shingubara, Minoh-city (JP); Hiroyuki Tomimoto, Tsukuba-city (JP); Toshio Sakurai, Fukuyama-city (JP); Masahiko Uchiyama, Fukuyama-city (JP); Sachiko Ishikawa, Hiroshima-city (JP)

Correspondence Address: OLIFF & BERRIDGE, PLC, P.O. BOX 320850, ALEXANDRIA, VA, 22320-4850, US

(73) Assignees: Rorze Corporation, Fukuyama-shi (JP); Daiken Chemical Co., Ltd., Osaka-shi (JP)

(21) Appl. No.: 12/458,634

(22) Filed: Jul. 17, 2009

Related U.S. Application Data
(62) Division of application No. 10/576,976, filed on Jul. 17, 2006.

(30) Foreign Application Priority Data
Oct. 22, 2003 (JP) 2003-361401

(51) Int. Cl. C09D 5/00

(52) U.S. Cl. 106/287.2; 106/287.3; 106/287.26

(57) ABSTRACT

Diamond fine particles having porous structure known in a high thermal resistance and low dielectric constant film has a high thermal conductivity and is expected as an insulating film for multiplayer wirings of a semiconductor integrated circuit device. A liquid composition of diamond fine particles, which are raw material of the film, is unstable as colloid, resulting in low reproducibility and yield in the production of films. It becomes possible to impart a very low viscosity and improved stability to the colloid liquid composition of diamond fine particles by containing a small amount of amine. If necessary, a thickener may be used to adjust the viscosity appropriately, so that various kinds of application systems can be used. A low dielectric constant film having a relative dielectric constant of about 2.5 can be thus obtained. Further, the liquid composition may be utilized as an abrasive for finishing.

This is a Divisional of application Ser. No. 10/576,976, filed Jul. 17, 2006, which is a National Stage Application of PCT/JP2004/015973, filed Oct. 21, 2004. The entire disclosures of the prior applications are hereby incorporated by reference herein in their entirety.

### TECHNICAL FIELD

The present invention relates to liquid composition with diamond fine particles dispersed, a low dielectric constant thin film having porous structure and composed of diamond fine particles as an insulating film, and an electronic component such as a semiconductor integrated circuit device of high integration degree and high speed operation type having the low dielectric thin film.

### BACKGROUND ART

Among semiconductor integrated circuit devices, particularly in super LSI devices, delay of signals passing through wirings prepared in the devices gives rise to a significant problem along with lowering of power consumption as the wirings become finer and are more integrated. Particularly, in a high speed logic device, RC delay due to the resistance and the distribution capacity of wirings result in most prominent subject and, among all, it is necessary to use a material of low dielectric constant for inter-wiring insulating materials in order to decrease the distribution capacity.

Heretofore, as an insulating film in a semiconductor integrated circuit, a silica film (SiO2), a tantalum oxide film (Ta2O5), an aluminum oxide film (Al2O3), a nitride film (Si3N4) and the like have been used and, particularly, as an insulating material between multilayer wiring, a nitride film and a silica film doped with an organic material or fluorine have been used or studied as the low dielectric constant film. Further, as an insulating film for further lowering the dielectric constant, a fluororesin, a silica film formed by baking a foaming organic silica film, a porous silica film formed by depositing fine silica particles, etc. have been studied.

Materials known so far as having low dielectric constant are listed in the following table.

| | Specific |
|---|---|
| Name of material | dielectric constant |
| Silica (plasma CVD) | 4.2-5.0 |
| Fluorine-added silica | 3.7 |
| Diamond | 5.68 |
| Porous silica | 1.5-2.5 |
| Porous diamond | 2.1-2.72 |
| Polyimide | 3.0-3.5 |
| Polytetrafluoroethylene | 1.9 |
| Air | 1.0 |

As described above, for further improvement of the integration degree, various studies have been made for obtaining materials having a relative dielectric constant being lower than 3.7 of the fluorine-added silica. Since the silica film per se comprises two kinds of atom elements of oxygen and silicon of high electronegativity, orientation polarization remains and it is insufficient as the low dielectric constant film, so that porous silica produced by a blowing method of fine particles has been studied. However, they are insufficient in the mechanical strength and have not yet been put to practical use. Further, while polytetrafluoroethylene as the fluororesin shown in the table has a sufficient relative dielectric constant, this can not be used since a severe condition for the required heat resistance of 400° C. or higher in the semiconductor manufacturing process can not be satisfied. While the polyimide is a heat resistant resin, it is carbonized at 400° C. or higher and can not be used as well.

On the other hand, since diamond is more excellent in the heat conductivity and the mechanical strength than other materials, this is a material suitable to heat dissipation for semiconductor devices of high integration degree and large heat generation amount and has been studied in recent years. For example, JP-A No. 6-97671 proposes a diamond film of 5 μm thickness by a film forming method such as a sputtering method, ion plating method or cluster ion beam method. Further, JP-A No. 9-263488 proposes a film forming method of scattering fine diamond particles on a substrate and growing diamond crystals using them as nuclei by supplying carbon by a CVD (Chemical Vapor Deposition) method.

The present inventors have obtained a relative dielectric constant of 2.72 by a fine diamond particle film of a porous structure as already disclosed in JP-A No. 2002-110870. Further, JP-A No. 2002-289604 proposes a reinforcing method by crosslinking fine diamond particles by means of a hexachlorodisiloxane treatment and it is shown that a relative dielectric constant comparable with that in JP-A No. 2002-110870 is obtained also by the treatment. Further, the present inventors have reported that a relative dielectric constant of 2.1 is obtained by heating and purifying fine diamond particles in the Academic Conference (The 50th meeting of the Japan Society of Applied Physics and Related Societies, Pre-text No. 2, p 913 (2003)).

### DISCLOSURE OF THE INVENTION

The present inventors have successfully obtained a low dielectric film having sufficiently high specific dielectric constant and strength as described above. As a result of a further study, it is proved that colloid state becomes unstable, even when the concentration of aqueous liquid composition of diamond fine particles before the application on a substrate is constant. The composition is gelled to jelly state, precipitates or is separated to phases when it is stayed for a long time, so that a stable film of porous structure cannot be obtained. Although Japanese patent publication 9-25110 does not describe the unstable state of the colloid, it is described that hydrophilic diamond fine particles can be obtained by purifying it with sulfuric acid or nitric acid due to hydroxyl groups generated on the surface of the particles. It is further proposed water or an alcohol as a dispersant. When the present inventors have tried to add ethyl alcohol to aqueous liquid composition of diamond fine particles, however, the phenomenon of the gelling cannot be solved although the viscosity can be lowered.

Heretofore, raw material of diamond fine particles produced by Explosion method contains amorphous carbon and graphite as impurities. The present inventors have purified the material with concentrated sulfuric acid or concentrated nitric acid to remove the impurities. As a course of further study, the present inventors have found that the material has an acidic pH of 2.0 to 4.5 even after the material is processed and sufficiently washed with water. It is further found that carboxyl groups as well as hydroxyl groups are generated on the surface of the diamond particles after the particles are treated with concentrated nitric acid, a nitride, perchloric acid, a perchloride, hydrogen peroxide, concentrated sulfuric acid or the like. It is further found that sulfonic groups are generated in addition to the above after the material is treated with concentrated sulfuric acid.

The present inventors have found that, by adding an amine substance to liquid composition composed of diamond fine particles and aqueous dispersant, the viscosity can be dramatically lowered and stable colloid state can be maintained without gelling, precipitation and phase separation even when the composition is set for several weeks. The present invention is based on the discovery.

According to the present invention, the liquid composition of diamond fine particles containing an amine substance does not result in gelling and precipitation and is capable of maintaining a low viscosity stably. It is thus possible to transport the composition with pipes and any type of applying system can be used, so that it is provided a great step in industrialization of semiconductor integrated circuit devices having the low dielectric constant films.

Further, the liquid composition of diamond fine particles containing an amine substance according to the present invention can be used as industrial abrasive materials, for example, for use in surface grinding of semiconductor wafers. Particularly, the composition may be used for abrasive papers and cloths obtained by applying the composition with a binder on a strength paper or a foundation cloth and abrasive parts obtained by solidifying the composition in a form of a grinder, as well as liquid abrasive obtained by dispersing diamond fine particles.

### BRIEF DESCRIPTION OF DRAWINGS

FIG. 1 is a graph showing relationship of viscosities and rotation rates in liquid compositions of diamond fine particles according to the present invention and comparative example.

FIG. 2 is a graph showing the distribution of particle diameter of dispersed particles in the liquid composition according to the present invention.

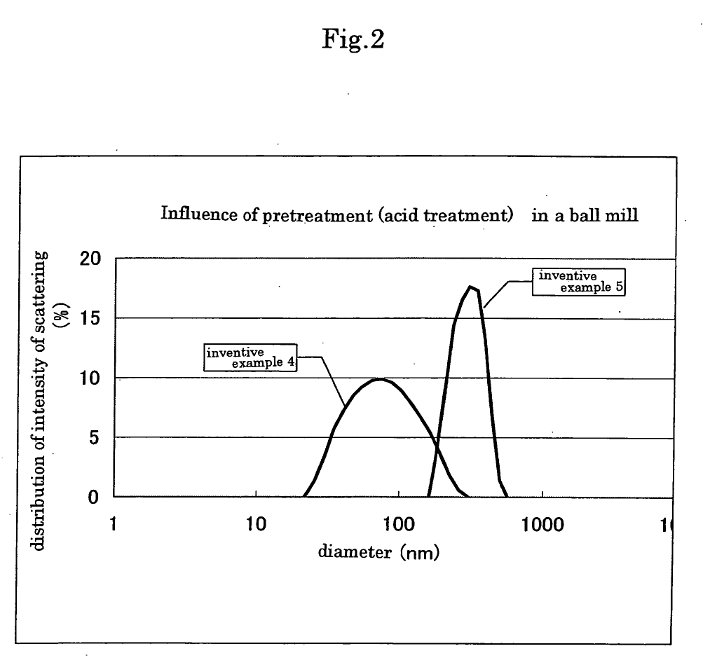

FIG. 3 is a graph showing the distribution of particle diameter of dispersed particles in the liquid composition according to another example of the present invention.

### BEST MODES FOR CARRYING OUT THE PRESENT INVENTION

An amine substance used in the present invention is not particularly limited, as far as it has a function of elevating pH of an acidic dispersion after coarse diamond is oxidized and purified and is soluble in a dispersant.

When the liquid composition is used for forming insulating films for semiconductor devices, an amine substance is preferred and a metal hydroxide is not preferred on the viewpoint of contamination. On the other hand, when the liquid composition is used for an abrasive, an amine substance is preferred.

The amine substance means organic and inorganic substances having an amine structure. Listed are ammonia, monoalkyl amine, dialkyl amine, trialkyl amine, N-monoalkylamino ethanol, N,N-dialkylamino ethanol, aniline, N-monoalkyl aniline, N, N-dialkyl aniline, morpholine, N-alkyl morpholine (the above alkyl groups have C1 to C12), mono(alkyl substituted phenyl)amine, diphenyl amine, triphenyl amine, benzyl amine, N-monoalkylbenzyl amine, N,N-dialkylbenzyl amine, N-alkyldiphenyl amine, triphenyl amine, pyridine, alkyl-substituted pyridine, monoethanol amine, diethanol amine, triethanol amine and tetraalkyl ammonium hydroxide. When the amine substance is volatile, it can be evaporated by heat treatment, so as to avoid residual amine in the insulating film and thus to prevent the adverse effects.

Amines having a boiling point of 50° C. or higher and 300° C. or lower, and preferably 50° C. or higher and 200° C. or lower may be preferred among the amine substances. That is, it is preferred that the amine substance forming salts with the carboxyl groups or sulfonic groups on the surface of the diamond fine particles do not evaporate from the liquid composition at room temperature and evaporate with a dispersant upon heating after the film formation.

The amount of addition of the amine substance in the liquid composition is changed depending on the particle diameter of diamond fine particles and the kind of the amine substance, and preferably 1 weight parts or higher and more preferably 2 weight parts or higher, with respect to 100 weight parts of diamond fine particles. Further, the amount of addition of the amine substance may preferably be 200 weight parts or lower and more preferably be 50 weight parts or lower. Specifically the amounts will described in the Examples section.

The amount of the diamond fine particles in the dispersion may preferably be 1 weight percent or higher and more preferably be 2 weight percent or higher, with respect to 100 weight percent of the whole of the dispersion. Further, the amount of the diamond fine particles in the dispersion may preferably be 50 weight percent or lower and more preferably be 20 weight percent or lower with respect to 100 weight percent of the whole dispersion.

According to the liquid composition of diamond fine particles of the present invention, as the dispersant, at least one elected from water, methanol, ethanol, n (or iso-) propanol, n (or iso, sec, or tert-) butanol, acetone, benzene, toluene, o (or/and m, p-) xylene, hexane, cyclohexane, gasoline, kerosene, methyl cellosolve, ethyl cellosolve, butyl cellosolve, dimethyl formamide, dimethyl acetoamide and dimethyl sulfoxide may be used alone or in combination of several kinds. Among these, water, an aqueous dispersant and a mixture of water and an aqueous dispersant are most preferred for performing ion reaction with carboxyl groups and sulfonic groups on the surface of diamond fine particles. The aqueous dispersant includes hydrophilic organic dispersants such as methanol, ethanol, isopropanol, dimethyl formamide, and dimethyl sulfoxide. On the other hand, according to the present invention, a specific amine substance may be selected and added to the diamond fine particles to make it lipophilic, so that the particles can be properly dispersed in an organic solvent.

The diamond fine particles may be dispersed to primary particles before/after the purifying step, or/and before the generation of the diamond colloid. The dispersion may be performed using a known system such as a homogenizer, a ball mill, a sand mill, or a bead mill. Further, as the dispersant, a known anion series surfactant, nonionic surfactant and various kinds of anti-foamants may be used. Of course, the alkaline substance used in the present invention can be used. When the composition is used as an electronic material for forming a thin film, it is preferably used a substance free from metal ions.

When the diamond fine particles are dispersed to primary particles, it is preferred to purify non-purified diamonds with acid treatment (at lease to a some degree), to add the alkaline substance according to the present invention for dispersing it by a known system and to purify it again with acid treatment. The diamond fine particles obtained by the procedure may be dispersed in a dispersant, so that diamond colloid solution having a small particle diameter with the particles stably dispersed can be obtained. Further, the diamond fine particles may be once dried after the purification. The method of drying may be conventional heat drying and may preferably be air drying at room temperature or freeze drying for preventing the coagulation of the fine particles. Further, the fine particles may not be completely dried to provide paste of a specific concentration, which is subjected to the subsequent step.

The liquid composition of diamond fine particles according to the present invention has a lower viscosity due to the addition of the alkaline substance. The concentration of the diamond fine particles may be adjusted or a thickener can be added for adjusting the viscosity depending on the use. The thickener includes polyethylene glycol, carboxymethyl cellulose, polyaclyric amide, polyvinyl alcohol, hydrolysate of styrene-maleic anhydride copolymer, hydrolysate of isobutylene-maleic anhydride copolymer and the like in aqueous dispersion, and polystyrene, styrene-maleic anhyrdire copolymer, isobutylrene-maleic anhydride copolymer, polyaclyric ester and the like in oily dispersion. Among these, polyethylene is preferred, and its molecular weight may preferably be 200 to 10000000.

According to the present invention, the viscosity is stabilized and optional viscosity can be obtained, so that any type of applicator of the liquid composition may be used such as spin coater, spray coater, bar coater, knife coater, ink jet coater and the like. Further, the liquid composition is not gelled so that it can be transported with pipes.

Further, the raw material of diamond fine particles according to the present invention are solid particles having a primary particle diameter of 1 nm to 50 nm and preferably be 2 nm to 20 nm, measured by an electron microscope. Further, the purity of diamond may preferably be 95 percent or higher, and a small amount of impurities such as graphite or amorphous carbon may be contained.

Generally, such fine particles having a diameter of nanometer range are not easily dispersed to primary particles and form coagulated dispersoid of several hundred nm to several thousands nm when they are dispersed in colloid dispersion. According to the present invention, the average particles diameter of the diamond fine particles can be lowered from several thousands nm to several nm to several tens nm by known dispersing means such as a ball mill or bead mill under the presence of the alkaline substance, particularly amine substance. It is thus possible to provide the stability of colloid. The advantage was considerable particularly when sulfonic groups are generated on the surface of the diamond fine particles by the process using sulfonic acid.

The liquid composition of diamond fine particles according to the present invention may be applied onto a substrate so that a low dielectric constant film of diamond fine particles having pores can be manufactured. The pore ratio may preferably be 40 percent to 70 percent. After the application, the film may be strengthened with hexachlorodisiloxane or the like. Further, the low dielectric constant film may be treated with aqueous solution of a barium salt or the like to make carboxyl or sulfonic groups on the surface of the diamond fine particles insoluble for improving the electrical properties

The film of diamond particles according to the present invention has pores and the surface is thus coarse, so that the surface may be densified. For this, known methods such as SOG (Spin on Glass) method, SG (Silicate Glass) film method, BPSG (Boron Phosphorous SG) film method and plasma CVD method may be used.

The present invention includes a semiconductor integrated circuit device having the low dielectric constant film of diamond fine particles. That is, the liquid composition is applied on a single crystal silicon substrate having a drawn circuit and a glass substrate having a drawn conductive film or a drawn circuit to form an insulating film, which may be subjected to a desired processing using a know method to produce an electronic device such as a semiconductor integrated circuit device of high integration and high speed operation. The electronic part may further be a general semiconductor device, a micro machine and condenser having the low dielectric constant film according to the present invention.

Further, the composition may be utilized in applications requiring stable viscosity property such as an industrial liquid abrasive for surface grinding of a semiconductor wafer, for example. Further, the industrial liquid abrasive may include an alkaline substance, which would not be problematic if remained in the film, such as an alkali metal including sodium hydroxide, potassium hydroxide and lithium hydroxide and an alkaline earth metal including calcium hydroxide, barium hydroxide or the like, in addition to the above amine substance. These metal hydroxides are not volatile. When the film or mold of the liquid composition of the present invention is dried, the dispersant is evaporated and the metal hydroxide as well as the main component (diamond particles) of the abrasive remain in the abrasive. Of course, when only the volatile amine substance is used as the alkaline substance, the alkaline substance does not substantially remain in the abrasive. Further, the liquid composition or abrasive according to the present invention may contain a grinding aid such as oxalic acid for use in a known CMP method (Chemical Mechanical polishing).

### EXAMPLES

Examples of the invention are to be described below but the invention is not limited only to the examples.

### Example 1

### Purification of Diamond Raw Material)

0.6 g of commercial cluster diamond manufactured by explosion method (average particle diameter of 5 nm measured by an electron microscope: Raman spectroscopy: diamond, 80 percent, graphite: 6 percent, amorphous carbon: about 10 percent, carbon single bond component: 4 percent) was contained in a quartz flask with 55 ml of 10% conc. nitric acid-conc. sulfuric acid, and then boiled for 2 hours at a temperature of 300 to 310° C. After cooling to room temperature, a large amount of water was added and then centrifuged, followed by decantation. The process was repeated until the pH exceeds 3 for the purification, the mixture was freeze dried under vacuum to provide purified diamond fine particles. The purity was measured and proved that the ratio of diamond was 96.5 percent, graphite 1.5 percent, amorphous carbon about 0 percent and a carbon single bond component 2.5 percent.

### (Preparation of Liquid Composition)

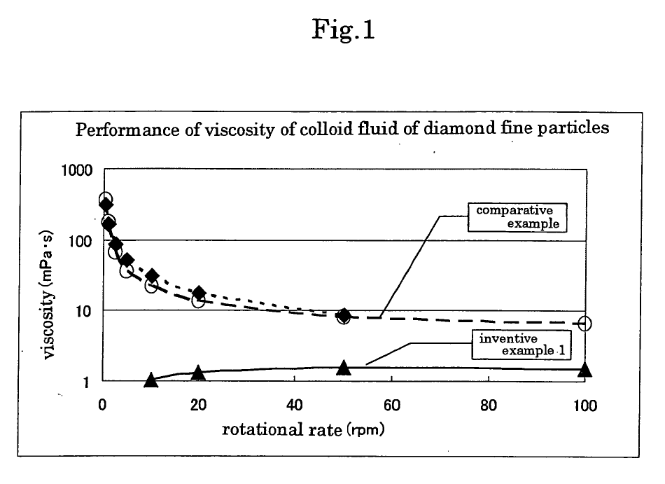

The purified diamond fine particles and water were charged in a quartz beaker so that the amount of the fine particles was made 5 weight percent. “Polyethylene glycol 600” was added so that the amount is 1 weight percent, and the beaker was immersed in a ultrasonic water bath for sufficiently dispersing for 2 hours to obtain a viscous dispersion. 0.1 weight percent of dimethylamino ethanol was added and agitated, and the rotation rate was elevated to 10 to 100 rpm for measuring the viscosity using an E-type viscometer (Tokyo Keiki Co., Ltd.: 25.0° C.). The viscosity proved to be 1 to 1.5 mPa·sec and substantially constant as shown in a line formed by triangle plots in FIG. 1. On the contrary, the viscosity was measured while the rotational rate was lowered from a high value, so that the plots were on the same line without change. The viscosity was proved to be low even after 1 month. The liquid composition of a low viscosity could be applied using a commercial ink jet printer (Seiko Epson Co. Ltd. MJ-1000V2 type). Further, the amount of the amine substance was 2.0 weight parts with respect to 100 weight parts of the diamond particles.

### Comparative Example 1

The liquid composition described above before the addition of dimethylamino ethanol was subjected to the measurement of the viscosity using an E-type viscometer (supplied by Tokyo Keiki Co. Ltd.: 25.0° C.) while the rotation rate was changed. As shown in the line formed by rhombus plots shown in FIG. 1, the viscosity was as high as 300 mPa·sec at 0.5 rpm, and lowered to 15 mPa·sec at 20 rpm and 8 mPa·sec at 100 rpm, respectively. Further, as the rotation rate is then lowered, as shown in the line formed by white circle plots in FIG. 1, the viscosity was made higher as the rotation rate is lower and the viscosity was proved to be lower than that of the previous example. The liquid composition was stayed for 2 days at room temperature, so that the composition was gelled to form agar like substance, which could be flown upon vigorous agitation of the container.

### Example 2

0.6 weight percent of dimethylamino ethanol aqueous solution was prepared and contained in a quartz beaker with the fine particles of purified diamine obtained in the example 1 so that the concentration of the fine particles becomes 10 weight percent. The beaker was immersed in ultrasonic water bath for 2 hours to disperse the purified diamond fine particles in water to obtain colloid solution. The colloid solution was then stayed for several days. The liquid composition was uniformly dispersed without gelling, phase separation and precipitation. Besides, the amount of the amine substance was 6 weight parts with respect to 100 weight parts of the diamond particles.

### Example 3

2.0 weight percent of aqueous solution of amino ethanol was used to produce colloid solution instead of 0.6 weight percent of dimethylamino ethanol aqueous solution in the example 2. The solution was stayed. The colloid solution was uniformly dispersed without gelling, phase separation and precipitation. The amount of the amine substance was 20 weight parts with respect to 100 weight percent of the diamond particles.

### Example 4

2.27 g of the purified diamond fine particles obtained in example 1 (having a content of graphite of 1.2 percent), 25.14 g of pure water, 0.25 g of dimethylamino ethanol and 39.75 g of zirconium oxide balls were charged in a container of a ball mill (Irie Shokai Co. Ltd.) and dispersed for 72 hours. The used balls have a diameter of 0.5 mm. The liquid composition of the diamond fine particles after the dispersion was proved to be blackish liquid. Average particle diameter of the dispersoid was 78.4 nm (the particle diameter was measured by a laser measurement system of zeta potential “ELS-8000” supplied by Otsuka electron Co. Ltd.). Stable liquid composition without gelling, precipitation and phase separation was obtained. The liquid composition could be applied using a commercial ink jet printer (Seiko Epson Co. Ltd. MJ-1000V2 type). The amount of the amine substance was 11 weight parts with respect to 100 weight parts of the diamond particles.

### Example 5

In the example 4, 2.69 g of commercial coarse diamond powder (having a graphite content of 7.0 percent) instead of the purified diamond, 29.43 g of pure water, 0.26 g of dimethylamino ethanol and 39.89 g of zirconium oxide balls were charged and dispersed for 72 hours. The colloid solution of the diamond fine particles after the dispersion was stable dispersion without gelling, precipitation and phase separation. The average particle diameter of the dispersoid was 344 nm (measured by the above system). The amount of the amine substance was 9.7 weight parts with respect to 100 weight parts of the diamond particles.

### Example 6

In the example 1, 1 percent of polyethylene glycol having a molecular weight of 500000 was added to the liquid composition instead of “Polyethylene glycol 600”. The viscosity was substantially constant and 10 mPa·sec irrespective of the rotation rate, and the composition was applied using a spin coater at a rotation rate of 1500 rpm, dried and then sintered for 1 hour at 300° C. using a hot plate. Thereafter, it was treated with steam of hexachlorodisiloxane at 300° C. for 1 hour using a hot plate. The applied film had interference color, a substantially constant thickness of 510 nm and a relative dielectric constant of 2.5.

### Example 7

The procedure of example 1 was performed except that diamond fine particles having a diameter of 1 to 3 μm were used as raw material. The particles were oxidized for the purification, purified and washed with water to obtain dispersion of pH of 3.5, which was then dried. 1 weight part of the purified diamond fine particles, 1 weight part of phenolic resin as a binder and 10 weight parts of methyl isobutyl ketone as a solvent were well mixed in a ball mill to obtain liquid composition of diamond fine particles. It was then applied onto a foundation cloth of cotton with a bar coater to a wet thickness of 80 micrometer and heated to 80° C. for drying and cross-linking the resin. The thus obtained foundation cloth applied with a film of the diamond fine particles is useful as a abrasive cloth for the surface finishing of a glass or a metal.

### Example 8

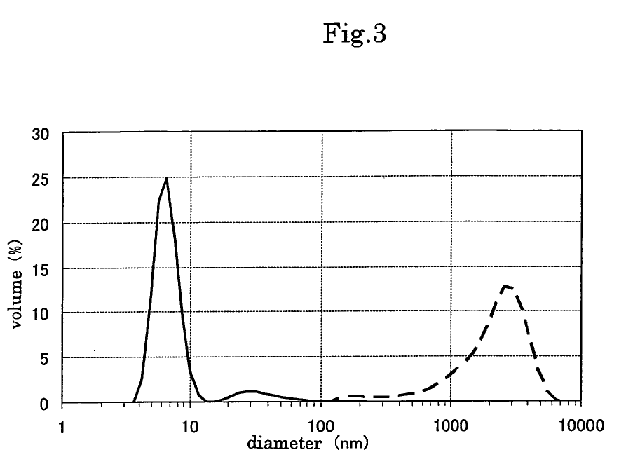

5 weight percent of the diamond fine particles purified by a method of the example 1 was charged into a bead mill (manufactured by Kotobuki Engineering & Manufacturing Co. Ltd.) with 0.5 weight percent of dimethylamino ethanol and zirconia beads of 0.05 mm and ground for 75 minutes. FIG. 3 shows the distribution of the particle diameters before the treatment with bead mill (broken lines) and after the treatment (solid lines). The coagulated diamond fine particles having a peak value of 2700 nm were ground by the treatment to a peak value of 7 nm, which is close to a primary particle diameter observed by an electron microscope.

### Comparative Example 2

5 weight percent of the diamond fine particles purified according to the method of the example 1 were ultrasonically dispersed to obtain gray composition. 5 weight percent of commercial nonionic surfactant (“EMULGEN 120” manufactured by Kao Corporation) was added to the composition and sufficiently agitated and mixed. The performance of viscosity of the composition was measured according to the same procedure as the example 1 to prove to be 60 mPa·sec at 0.5 rpm, 10 mPa·sec at 20 rpm and 5 mPa·sec at 100 rpm, respectively. Although the viscosity was lowered with respect to that in the comparative example 1, the thixotropic performance of viscosity was not changed. The composition was gelled to agar like state after it is stayed for several days, so that stable colloid solution was not obtained.

### Comparative Example 3

5.8 weight percent of the raw material of the diamond fine particles of the example 1, 1.23 weight percent of anion surfactant (“MX-2045L: ammonium salt of condensation product of naphthalene sulfonic acid and form aldehyde: manufactured by Kao corporation) and water were charged into a ball mill containing zirconia balls having a diameter of 2 mm, and then ground for 48 hours. The thus obtained liquid mixture was removed and stayed for 3 days. Much amount of precipitation was generated and phase separation occurred, so that stable colloid liquid composition cannot be obtained.

### INDUSTRIAL APPLICABILITY

According to the present invention, it can be provided liquid composition of diamond fine particles having a low and stable viscosity, which is extremely important in an industry. It is found that a uniform film of diamond fine particles can be formed by the application of the composition with various kinds of application systems. It is proved that such film is an inorganic and low dielectric constant film superior in heat resistance and thermal conductivity whose relative dielectric constant can be extremely low value of 2.5. It is thus possible to manufacture high performance electronic devices such as high performance condenser as well as multi layer semiconductor device and semiconductor capacitor. Further, the liquid composition may be applied onto a foundation cloth or the like and utilized as an abrasive.

1. A low dielectric constant film obtained by applying a liquid composition, said liquid composition comprising at least diamond fine particles purified and oxidized by heating with a purifying agent, a dispersant, and an amine substance.

2. The film of claim 1, wherein said amine substance has a boiling point of 50° C. or higher and 300° C. or lower.

3. The film of claim 1, wherein said dispersant comprises water, a water soluble dispersant, or a mixture of water and a water soluble dispersant.

4. The film of claim 1, wherein said purifying agent comprises concentrated nitric acid, a nitride, perchloric acid, a perchloride, hydrogen peroxide, or concentrated sulfuric acid.

5. The film of claim 1, wherein said diamond fine particles have a purity of 95 percent or higher.

6. The film of claim 1, wherein said diamond fine particles are obtained by purifying raw diamond particles having a primary particle diameter of 1 nm to 50 nm.

7. The film of claim 1, wherein said amine substance is selected from the group consisting of aniline, morpholine, benzyl amine, pyridine, monoethanol amine, diethanol amine, monoalkyl amine, dialkyl amine, trialkyl amine, N-monoalkylamino ethanol, N,N-dialkylamino ethanol, N-monoalkyl aniline, N,N-dialkyl aniline, N-alkyl morpholine, mono(alkyl substituted phenyl)amine, N-monoalkylbenzyl amine, N,N-dialkylbenzyl amine, and alkyl-substituted pyridine.

8. An electronic component comprising said low dielectric constant film of claim 1.
